(19) United States
(12) Patent Application Publication
(10) Pub. No.: US 2026/0009650 A1
(43) Pub. Date: Jan. 8, 2026

(54) Method and System for Smart Allocation of Charing Station and Computer Program Product

(71) Applicant: Mercedes-Benz Group AG, Stuttgart (DE)

(72) Inventors: Xue MEI, Beijing (CN); Bernd HEINTEL, Stuttgart (DE); Stefan UEBENER, Boeblingen (DE)

(21) Appl. No.: 19/111,954

(22) PCT Filed: Sep. 14, 2023
(86) PCT No.: PCT/EP2023/025399

§ 371 Date: Mar. 14, 2025

(30) Foreign Application Priority Data
Sep. 15, 2022 (CN) 202211122298.4

(51) Int. Cl. G01C 21/34; B60L 53/62; B60L 53/63; B60L 53/65; G06Q 10/02

(52) U.S. Cl. CPC G01C 21/3469; B60L 53/62; B60L 53/63; B60L 53/65; G01C 21/3476; G06Q 10/02

(57) ABSTRACT

A method for smart allocation of a charging station includes acquiring vehicle charging information, selecting, on a basis of the acquired vehicle charging information, a vehicle of which charging behavior is regular, and obtaining navigation information of a target vehicle and allocating a charging station to the target vehicle on a basis of the navigation information of the target vehicle and charging information of the vehicle of which charging behavior is regular.

### BACKGROUND AND SUMMARY OF THE INVENTION

The present invention relates to the technical field of charging of electric vehicles, and in particular to a method for smart allocation of a charging station, a system for smart allocation of a charging station, and a computer program product for performing the method.

Currently, as the number of electric vehicles traveling on public roads increases constantly, the demand for charging infrastructure for electric vehicles is increasingly larger. A charging station can provide a parking space and a charging pile for an electric vehicle. However, a limited number of charging stations can be provided in the urban area. When a charging station is recommended to a user, the occupancy or queuing status of the charging station is particularly important, and a lengthy queuing time deteriorates user experience. However, the existing charging station recommendation scheme considers only the current status of charging stations. Since information exchange between a user end and a charging end lags behind, a user cannot accurately predict a status of a charging station when navigating to the charging station. For example, a charging station may have idle charging piles when a vehicle initiates navigation, but all the charging piles of the charging station may be occupied when the vehicle reaches the charging station.

Therefore, how to smartly allocate a charging station to an electric vehicle becomes a technical problem to be solved at present.

An objective of the present invention is to provide a method for smart allocation of a charging station, a system for smart allocation of a charging station, and a computer program product for performing the method, so as to address the problem in the prior art. The core idea of the present invention is as follows: a vehicle of which charging behavior is regular is selected from acquired vehicle charging information, and status information of a charging station can be predicted on the basis of the charging information of the vehicle of which the charging behavior is regular. When a navigation route of a target vehicle is planned, a charging station is allocated to the target vehicle on the basis of charging habit of the target vehicle and the predicted status information of the charging station. According to the present invention, a navigation route of a target vehicle can be planned more reasonably, thereby effectively reducing a queuing time in a charging station, and improving travel experience of a user.

According to a first aspect of the present invention, provided is a method for smart allocation of a charging station, comprising:
step S1: acquiring vehicle charging information;
step S2: selecting, on the basis of the acquired vehicle charging information, a vehicle of which charging behavior is regular; and
step S3: obtaining navigation information of a target vehicle, and allocating a charging station to the target vehicle on the basis of the navigation information of the target vehicle and the charging information of the vehicle of which the charging behavior is regular.

According to an optional embodiment of the present invention, the method may further comprise:
step S21: assessing, on the basis of the acquired vehicle charging information, and storing a leaving time when the vehicle of which the charging behavior is regular leaves the charging station.

Optionally, in step S3, the charging station is allocated to the target vehicle on the basis of the navigation information of the target vehicle and the stored leaving time, wherein the stored leaving time is used to predict a status of the charging station. Status information of a charging station can be accurately predicted in this manner, thereby improving efficiency and accuracy of smart allocation of a charging station.

According to an optional embodiment of the present invention, in step S2, the selection is performed at a preset time interval, wherein the vehicle charging information, on which the selection is based, varies over time during acquisition. Re-performing the selection at the preset time interval can improve accuracy of the selection.

According to an optional embodiment of the present invention, step S3 may comprise:
step S301: obtaining the navigation information of the target vehicle, wherein the navigation information comprises a navigation destination;
step S302: predicting, on the basis of the stored leaving time of the vehicle of which the charging behavior is regular, status information of a charging station within a preset region range of the navigation destination;
step S303: allocating a charging station to the target vehicle on the basis of the navigation information of the target vehicle and the predicted status information of the charging station; and
step S304: presenting, to a user of the target vehicle, location information of the allocated charging station and a navigation route to the allocated charging station.

Herein, in a simple manner, the efficiency and accuracy of the smart allocation of the charging station are improved, and travel experience of the user is improved.

According to an optional embodiment of the present invention, in step S303, it is determined, on the basis of the navigation information of the target vehicle and the predicted status information of the charging station, whether an idle charging station is present in the preset region range of the navigation destination at a predicted time when the target vehicle reaches the navigation destination, wherein if an idle charging station is present in the preset region range of the navigation destination at the predicted time, then a charging station closest to the navigation destination is allocated to the target vehicle, or if no idle charging station is present in the preset region range of the navigation destination at the predicted time, then priority ranking is performed on charging stations in the preset region range of the navigation destination on the basis of a preset recommendation criterion, and a charging station is allocated to the target vehicle on the basis of the priority ranking of the charging stations, wherein different influencing factors are set for factors such as a distance to the navigation destination, a queuing time length, and the like according to the preset recommendation criterion, and the priority ranking is performed on the charging stations.

According to an optional embodiment of the present invention, step S3 may comprise:
step S311: obtaining the navigation information of the target vehicle, and determining, on the basis of the acquired vehicle charging information, whether charging behavior of the target vehicle is regular;
step S312: if the charging behavior of the target vehicle is regular, then assessing a charging start time of the target vehicle on the basis of the acquired charging information of the target vehicle, and predicting a predicted charging location of the target vehicle on the basis of the navigation information and the charging start time of the target vehicle;
step S313: predicting, on the basis of the stored leaving time of the vehicle of which the charging behavior is regular, status information of a charging station in a preset region range of the predicted charging location;
step S314: allocating a charging station to the target vehicle on the basis of the navigation information of the target vehicle and the predicted status information of the charging station; and
step S315: presenting, to a user of the target vehicle, location information of the allocated charging station and a navigation route to the allocated charging station.

Herein, the planned navigation route of the target vehicle is more compliant with charging habit of the target vehicle, thereby improving the travel experience of the user.

According to an optional embodiment of the present invention, in step S314, it is determined, on the basis of the charging start time of the target vehicle and the status information of the charging station in the preset region range of the predicted charging location, whether an idle charging station is present in the preset region range of the predicted charging location at the charging start time, wherein if an idle charging station is present in the preset region range of the predicted charging location at the charging start time, then an idle charging station closest to the predicted charging location is allocated to the target vehicle, or if no idle charging station is present in the preset region range of the predicted charging location at the charging start time, then priority ranking is performed on charging stations in the preset region range of the predicted charging location on the basis of a preset recommendation criterion, and a charging station is allocated to the target vehicle on the basis of the priority ranking of the charging stations, wherein different influencing factors are set for factors such as a distance to the predicted charging location, a queuing time length, and the like according to the preset recommendation criterion, and the priority ranking is performed on the charging stations.

According to an optional embodiment of the present invention, step S3 may comprise:
step S321: obtaining the navigation information and current charge level information of the target vehicle, wherein the navigation information comprises a navigation destination;
step S322: determining, on the basis of the current charge level information and the navigation information of the target vehicle, whether a current charge level of the target vehicle is sufficient to enable the target vehicle to reach the navigation destination;
step S323: if the current charge level of the target vehicle is not sufficient to enable the target vehicle to reach the navigation destination, then determining a predicted charging location and a predicted charging time of the target vehicle on the basis of the navigation information and the current charge level information of the target vehicle;
step S324: predicting, on the basis of the stored leaving time of the vehicle of which the charging behavior is regular, status information of a charging station in a preset region range of the predicted charging location;
step S325: allocating a charging station to the target vehicle on the basis of the navigation information of the target vehicle and the predicted status information of the charging station; and
step S326: presenting, to a user of the target vehicle, location information of the allocated charging station and a navigation route to the allocated charging station.

Herein, the charge level information of the vehicle may be sufficiently considered when the navigation route of the vehicle is planned, thereby avoiding an accident in which electricity is used up before the vehicle reaches the navigation destination, thereby improving the travel experience of the user.

According to an optional embodiment of the present invention, in step S325, it is determined, on the basis of the predicted charging time of the target vehicle and the status information of the charging station in the preset region range of the predicted charging location, whether an idle charging station is present in the preset region range of the predicted charging location at the predicted charging time, wherein if an idle charging station is present in the preset region range of the predicted charging location at the predicted charging time, then an idle charging station closest to the predicted charging location is allocated to the target vehicle, or if no idle charging station is present in the preset region range of the predicted charging location at the predicted charging time, then priority ranking is performed on charging stations in the preset region range of the predicted charging location on the basis of a preset recommendation criterion, and a charging station is allocated to the target vehicle on the basis of the priority ranking of the charging stations, wherein different influencing factors are set for factors such as a distance to the predicted charging location, a queuing time length, and the like according to the preset recommendation criterion, and the priority ranking is performed on the charging stations.

According to an optional embodiment of the present invention, the acquired vehicle charging information comprises, for example, a vehicle identifier, charging station basic information, an on/off signal of a charging pile, a charging current signal of the charging pile, vehicle start information, vehicle speed information, and/or vehicle location information, wherein the charging station basic information comprises, for example, a charging station identifier, charging station location information, the number of charging piles of a charging station, and/or a charging pile type.

According to a second aspect of the present invention, provided is a system for smart allocation of a charging station, the system being used to perform the method according to the present invention. The system comprises one or more of the following components: a charging information acquisition module, configured to acquire vehicle charging information; a charging information processing module, configured to select, on the basis of the acquired vehicle charging information, a vehicle of which charging behavior is regular; a storage module, configured to store the charging information of the vehicle of which the charging behavior is regular; a navigation module, configured to obtain navigation information input by a user of a target vehicle, high-definition map information labeled with charging station basic information being stored in the navigation module; an allocation module, configured to allocate a charging station to the target vehicle according to the navigation information and the stored charging information of the vehicle of which the charging behavior is regular; and an information notification module, configured to notify, to the user, location information of the allocated charging station and a navigation route to the allocated charging station.

According to a third aspect of the present invention, provided is a computer program product, such as a computer readable program carrier, comprising computer program instructions implementing, when executed by a processor, the steps of the method according to the present invention.

The principles, features, and advantages of the present invention can be better understood via further detailed description of the present invention provided with reference to the accompanying drawings.

### BRIEF DESCRIPTION OF THE DRAWINGS

FIG. 1 shows a flowchart of a method for smart allocation of a charging station according to an exemplary embodiment of the present invention;

FIG. 2 shows a flowchart of a method for smart allocation of a charging station according to another exemplary embodiment of the present invention;

FIG. 3 shows a flowchart of a method for smart allocation of a charging station according to another exemplary embodiment of the present invention;

FIG. 4 shows a flowchart of a method for smart allocation of a charging station according to another exemplary embodiment of the present invention;

FIG. 5 shows a flowchart of a method for smart allocation of a charging station according to another exemplary embodiment of the present invention; and

FIG. 6 shows a block diagram of a system for smart allocation of a charging station according to an exemplary embodiment of the present invention.

### DETAILED DESCRIPTION OF THE DRAWINGS

In order to make the technical problems to be solved by the present invention, the technical solutions, and the beneficial technical effects clearer, the present invention will be described below in further detail with reference to the accompanying drawings and a plurality of exemplary embodiments. It should be understood that specific embodiments described herein are merely used to explain the present invention, but are not used to limit the scope of protection of the present invention.

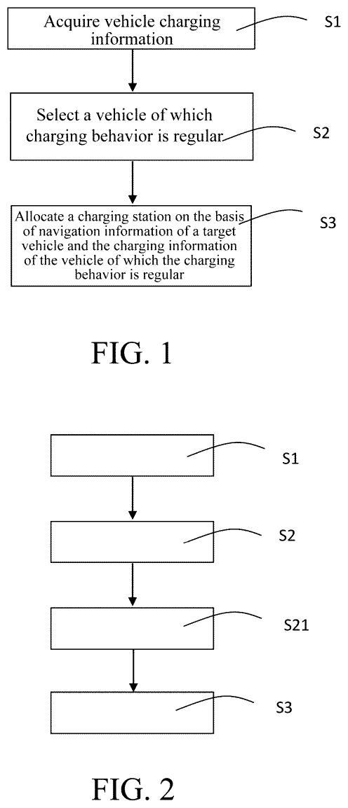

FIG. 1 shows a flowchart of a method for smart allocation of a charging station according to an exemplary embodiment of the present invention. The following exemplary embodiments describe in further detail the method according to the present invention.

The method includes steps S1 to S3. In step S1, acquiring vehicle charging information. In this embodiment of the present invention, the acquired vehicle charging information includes, for example, a vehicle identifier (e.g., a license plate number), charging station basic information, an on/off signal of a charging pile, a charging current signal of the charging pile, vehicle start information, vehicle speed information, and/or vehicle location information. The charging station basic information includes, for example, a charging station identifier, charging station location information, the number of charging piles of a charging station, and/or a charging pile type. Herein, it can be determined, on the basis of the on/off signal of the charging pile and/or the charging current signal of the charging pile, whether charging of the vehicle is completed. The charging station includes one or more charging piles, and the charging station, particularly a smart charging station, can upload an on/off signal and/or a charging current signal of each charging pile thereof to a back-end server. On this basis in conjunction with the vehicle start information, the vehicle speed information, and/or the vehicle location information, it can be determined whether the vehicle leaves the charging station after the charging is completed. The vehicle start information, the vehicle speed information, and/or the vehicle location information may be acquired via, for example, a charging information acquisition module 11, particularly a real-time monitoring system. For example, if, within a preset time period after detection of an off signal of the charging pile, a vehicle start signal is detected and/or it is detected that vehicle speed increases from zero, then it is determined that the vehicle leaves the charging station after the charging is completed.

It should be noted that when the vehicle charging information is acquired, the vehicle identifier (e.g., the license plate number) may be associated with remaining vehicle charging information belonging to the vehicle, and a charging information archive may be established for each vehicle identifier.

In step S2, selecting, on the basis of the acquired vehicle charging information, a vehicle of which charging behavior is regular. In the meaning of the present invention, “charging behavior is regular” may be understood as follows: the vehicle is subjected to charging periodically at a fixed frequency in a fixed time period and repeatedly in a fixed charging station. The fixed time period (e.g., a fixed time period of each day or a fixed time period of each week) and/or the fixed frequency (e.g., a few times per day or once every few days) may be set on the basis of a preset criterion. The selection may be implemented via, for example, an artificial neural network model trained via big data.

Optionally, the selection may be performed at a preset time interval (e.g., once per week). It can be understood that the vehicle charging information, on which the selection is based, varies over time during acquisition. The charging habit (e.g., the time of leaving the charging station) of the vehicle reflected by the vehicle charging information may vary. Therefore, re-performing the selection at the preset time interval can improve accuracy of the selection.

In step S3, obtaining navigation information of a target vehicle, and allocating a charging station to the target vehicle on the basis of the navigation information of the target vehicle and the charging information of the vehicle of which the charging behavior is regular. Herein, navigation information input by a user of the target vehicle is obtained via a navigation module 14, and the navigation information particularly includes a navigation destination. High-definition map information is stored in the navigation module 14. The high-definition map information may include not only basic map information for vehicle navigation but also the charging station basic information (e.g., the charging station identifier, the charging station location information, the number of charging piles of the charging station, and/or the charging pile type, etc.), and optionally, may further include real-time traffic status information used to predict speed of the target vehicle traveling along the navigation route. For example, the time when the target vehicle reaches the navigation destination can be predicted on the basis of the navigation information of the target vehicle, and status information of a charging station in a preset region range (for example, within a range of one kilometer) of the navigation destination at the time is further predicted on the basis of the charging information of the vehicle of which the charging behavior is regular. The status information includes, for example, an idle state or an occupied state, and may even include a queuing time length. Therefore, a charging station, such as an idle charging station closest to the navigation destination, is allocated to the target vehicle on the basis of the predicted status information of the charging station. This will be explained in detail in optional embodiments of the present invention.

According to this embodiment of the present invention, the acquired vehicle charging information is analyzed and processed to predict the status information of the charging station in the navigation route of the target vehicle, and the suitable charging station is allocated to the target vehicle with reference to the navigation information of the target vehicle, so that the navigation route of the target vehicle can be planned more reasonably, thereby effectively reducing a queuing time in the charging station, and improving the travel experience of the user.

FIG. 2 shows a flowchart of a method for smart allocation of a charging station according to another exemplary embodiment of the present invention. Only differences from the embodiment shown in FIG. 1 are described below, and for brevity, the same steps will not be described again.

The method may further include step S21. In step S21, assessing, on the basis of the acquired vehicle charging information, and storing a leaving time when the vehicle of which the charging behavior is regular leaves the charging station. In an optional embodiment of the present invention, after the vehicle of which the charging behavior is regular is selected, the leaving time when the vehicle leaves the charging station may be assessed on the basis of the acquired vehicle charging information in, for example, the following manner: it can be determined, on the basis of the on/off signal of the charging pile and/or the charging current signal of the charging pile, whether charging of the vehicle is completed; after it is determined that the charging of the vehicle is completed, the leaving time when the vehicle leaves the charging station after the charging is completed may be assessed on the basis of the vehicle start information, the vehicle speed information, and/or the vehicle location information. The assessed leaving time may be stored in a storage module 13, particularly in the charging information archive established for each vehicle identifier, together with the vehicle identifier.

In step S3, the charging station may be allocated to the target vehicle on the basis of the navigation information of the target vehicle and the stored leaving time, wherein the stored leaving time when the vehicle of which the charging behavior is regular leaves the charging station may be used to predict the status information of the charging station.

According to an optional embodiment of the present invention, the leaving time when the vehicle of which the charging behavior is regular leaves the charging station is assessed and stored, so that the status information of the charging station can be predicted accurately in a simple manner, thereby improving the efficiency and accuracy of the smart allocation of the charging station.

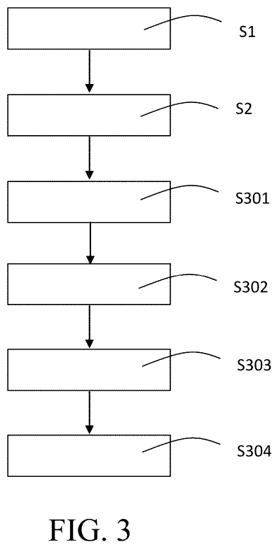

FIG. 3 shows a flowchart of a method for smart allocation of a charging station according to another exemplary embodiment of the present invention. Only differences from the embodiment shown in FIG. 1 are described below, and for brevity, the same steps will not be described again.

Step S3 may include steps S301 to S304. In step S301, obtaining the navigation information of the target vehicle, wherein the navigation information includes a navigation destination. In step S302, predicting, on the basis of the stored leaving time of the vehicle of which the charging behavior is regular, status information of a charging station within a preset region range of the navigation destination. Herein, the status information of the charging station includes, for example, an idle state or an occupied state, and may even include a queuing time length. The status information may be predicted on the basis of the leaving time of the vehicle subjected to charging regularly in the charging station. It should be noted that the premise of this embodiment of the present invention is the following fact: the charge level of the target vehicle is sufficient to enable the target vehicle to travel to the navigation destination input by the user. That is, after the target vehicle reaches the navigation destination, charging is performed in the vicinity of the navigation destination. The time when the target vehicle reaches the navigation destination can be predicted on the basis of the navigation information of the target vehicle.

In step S303, allocating a charging station to the target vehicle on the basis of the navigation information of the target vehicle and the predicted status information of the charging station. Herein, for example, it may be determined whether an idle charging station is present according to a predicted time when the target vehicle reaches the navigation destination and the status information of the charging station in the preset region range (for example, one kilometer) of the navigation destination at the predicted time. If an idle charging station is present in the preset region range of the navigation destination at the predicted time, then an idle charging station closest to the navigation destination is allocated to the target vehicle. If no idle charging station is present in the preset region range of the navigation destination at the predicted time, then priority ranking is performed on charging stations in the preset region range of the navigation destination on the basis of a preset recommendation criterion. Different influencing factors may be set for factors such as a distance to the navigation destination, a queuing time length, and the like according to the preset recommendation criterion, and the priority ranking is performed on the charging stations. A charging station, particularly a charging station having the short queuing time and the short distance, is allocated to the target vehicle on the basis of the priority ranking of the charging stations.

In step S304, notifying, to a user of the target vehicle, location information of the allocated charging station and a navigation route to the allocated charging station. Herein, the notification may be performed via an information notification module 16. The information notification module 16 includes, for example, a head-up display screen and/or a central control display screen.

According to an optional embodiment of the present invention, the status information of the charging station in the preset region range of the navigation destination is predicted on the basis of the leaving time of the vehicle of which the charging behavior is regular, and the suitable charging station is allocated to the target vehicle with reference to the navigation information of the target vehicle, thereby improving the efficiency and accuracy of the smart allocation of the charging station in a simple manner, and improving the travel experience of the user.

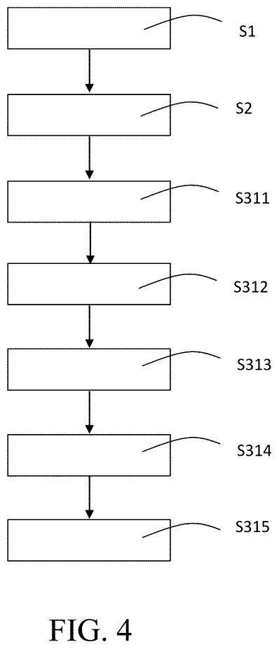

FIG. 4 shows a flowchart of a method for smart allocation of a charging station according to another exemplary embodiment of the present invention. Only differences from the embodiment shown in FIG. 1 are described below, and for brevity, the same steps will not be described again.

Step S3 may further include steps S311 to S315. In step S311, obtaining the navigation information of the target vehicle, and determining, on the basis of the acquired vehicle charging information, whether charging behavior of the target vehicle is regular. If the charging behavior of the target vehicle is regular, then in step S312, assessing a charging start time of the target vehicle on the basis of the acquired charging information of the target vehicle, and predicting a predicted charging location of the target vehicle on the basis of the navigation information and the charging start time of the target vehicle. It can be understood that, if the target vehicle has the habit of being subjected to charging in a fixed time period, then the planning of the navigation route of the target vehicle may consider guiding the target vehicle to the charging station in the fixed time period.

In step S313, predicting, on the basis of the stored leaving time of the vehicle of which the charging behavior is regular, status information of a charging station in a preset region range of the predicted charging location; and in step S314, allocating a charging station to the target vehicle on the basis of the navigation information of the target vehicle and the predicted status information of the charging station. As in the embodiment described above, likewise, it may be determined, on the basis of the charging start time of the target vehicle and the status information of the charging station in the preset region range (for example, one kilometer) of the predicted charging location, whether an idle charging station is present in the preset region range of the predicted charging location at the charging start time. If an idle charging station is present in the preset region range of the predicted charging location at the charging start time, then an idle charging station closest to the predicted charging location is allocated to the target vehicle. If no idle charging station is present in the preset region range of the predicted charging location at the charging start time, then priority ranking is performed on charging stations in the preset region range of the predicted charging location on the basis of a preset recommendation criterion. Different influencing factors are set for factors such as a distance to the predicted charging location, a queuing time length, and the like according to the preset recommendation criterion, and the priority ranking is performed on the charging stations. A charging station, particularly a charging station having the short queuing time and the short distance, is allocated to the target vehicle on the basis of the priority ranking of the charging stations.

In step S315, notifying, to a user of the target vehicle, location information of the allocated charging station and a navigation route to the allocated charging station. Herein, the notifying may be performed via an information notification module 16. The information notification module 16 includes, for example, a head-up display screen and/or a central control display screen.

According to an optional embodiment of the present invention, the planned navigation route of the target vehicle is more compliant with charging habit of the target vehicle, thereby improving the travel experience of the user.

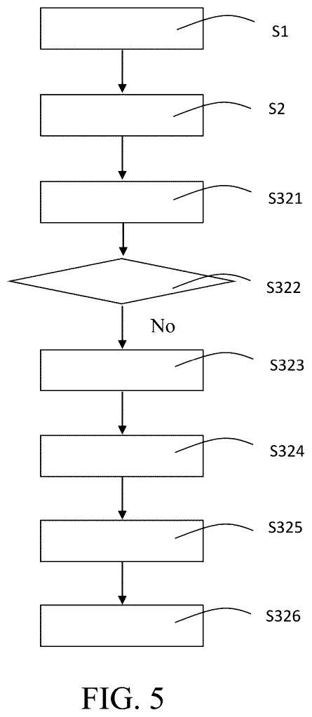

FIG. 5 shows a flowchart of a method for smart allocation of a charging station according to another exemplary embodiment of the present invention. Only differences from the embodiment shown in FIG. 1 are described below, and for brevity, the same steps will not be described again.

Step S3 may further include steps S321 to S326. In step S321, obtaining the navigation information and current charge level information of the target vehicle, wherein the navigation information includes a navigation destination. Herein, the current charge level information of the target vehicle may be acquired via the charging information acquisition module 11, particularly the real-time monitoring system.

In step S322, determining, on the basis of the current charge level information and the navigation information of the target vehicle, whether a current charge level of the target vehicle is sufficient to enable the target vehicle to reach the navigation destination. If the current charge level of the target vehicle is not sufficient to enable the target vehicle to reach the navigation destination, then in step S323: determining a predicted charging location and a predicted charging time of the target vehicle on the basis of the navigation information and the current charge level information of the target vehicle. Herein, a maximum travel distance supported by the charge level of the target vehicle may be calculated on the basis of the current charge level information of the target vehicle, and the predicted charging location along the navigation route and the predicted charging time when the target vehicle reaches the predicted charging location may be further determined on the basis of the navigation route from the navigation module 14 and the calculated maximum travel distance.

In step S324, predicting, on the basis of the stored leaving time of the vehicle of which the charging behavior is regular, status information of a charging station in a preset region range of the predicted charging location. In step S325, allocating a charging station to the target vehicle on the basis of the navigation information of the target vehicle and the predicted status information of the charging station. As in the embodiment described above, likewise, it may be determined, on the basis of the predicted charging time of the target vehicle and the status information of the charging station in the preset region range of the predicted charging location, whether an idle charging station is present in the preset region range of the predicted charging location at the predicted charging time. If an idle charging station is present in the preset region range of the predicted charging location at the predicted charging time, then an idle charging station closest to the predicted charging location is allocated to the target vehicle, or if no idle charging station is present in the preset region range of the predicted charging location at the predicted charging time, then priority ranking is performed on charging stations in the preset region range of the predicted charging location on the basis of a preset recommendation criterion. Different influencing factors are set for factors such as a distance to the predicted charging location, a queuing time length, and the like according to the preset recommendation criterion, and the priority ranking is performed on the charging stations. A charging station is allocated to the target vehicle on the basis of the priority ranking of the charging stations.

In step S326, presenting, to a user of the target vehicle, location information of the allocated charging station and a navigation route to the allocated charging station.

According to an optional embodiment of the present invention, the charge level information of the vehicle may be sufficiently considered when the navigation route of the vehicle is planned, thereby avoiding an accident in which electricity is used up before the vehicle reaches the navigation destination, thereby improving the travel experience of the user.

In addition, it should be noted that the step number described herein does not necessarily represent an order, but is merely a reference numeral. The order may be changed according to a specific situation, so long as the technical objective of the present invention can be achieved.

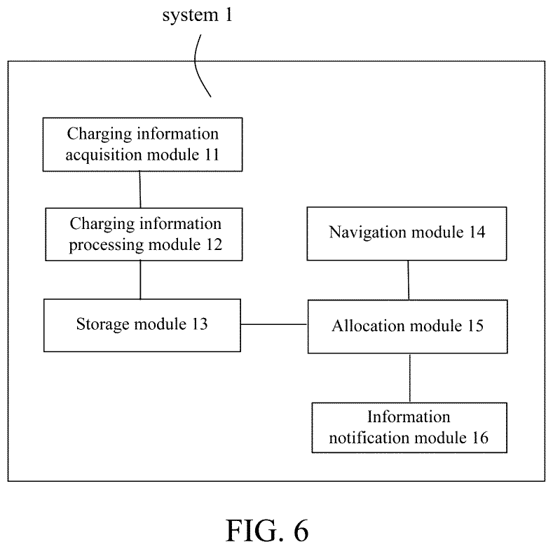

FIG. 6 shows a block diagram of a system for smart allocation of a charging station according to an exemplary embodiment of the present invention.

As shown in FIG. 6, the system 1 includes one or more of the following components: a charging information acquisition module 11, configured to acquire vehicle charging information and including, for example, a real-time monitoring system; a charging information processing module 12, configured to select, on the basis of the acquired vehicle charging information, a vehicle of which charging behavior is regular; a storage module 13, configured to store the charging information of the vehicle of which the charging behavior is regular; a navigation module 14, configured to obtain navigation information input by a user of a target vehicle, high-definition map information labeled with charging station basic information being stored in the navigation module 14; an allocation module 15, configured to allocate a charging station to the target vehicle according to the navigation information and the stored charging information of the vehicle of which the charging behavior is regular; and an information notification module 16, configured to notify, to the user, location information of the allocated charging station and a navigation route to the allocated charging station and including, for example, a head-up display screen and/or a central control display screen.

Although particular embodiments of the present invention are described in detail herein, the particular embodiments are merely for the purpose of explanation, and should not be considered to limit the scope of the present invention. Various replacement schemes and modification schemes may be provided without departing from the core and scope of the present invention.

1.-13. (canceled)

14. A method for smart allocation of a charging station, comprising:
step S1: acquiring vehicle charging information;
step S2: selecting, on a basis of the acquired vehicle charging information, a vehicle of which charging behavior is regular; and
step S3: obtaining navigation information of a target vehicle and allocating a charging station to the target vehicle on a basis of the navigation information of the target vehicle and charging information of the vehicle of which charging behavior is regular.

15. The method according to claim 14, further comprising:
step S21: assessing, on the basis of the acquired vehicle charging information, and storing a leaving time when the vehicle of which charging behavior is regular leaves the charging station.

16. The method according to claim 15, wherein in step S3, the charging station is allocated to the target vehicle on the basis of the navigation information of the target vehicle and the stored leaving time, wherein the stored leaving time is used to predict a status of the charging station.

17. The method according to claim 14, wherein step S3 comprises:
step S301: obtaining the navigation information of the target vehicle, wherein the navigation information comprises a navigation destination;
step S302: predicting, on the basis of the stored leaving time of the vehicle of which charging behavior is regular, status information of a charging station within a preset region range of the navigation destination;
step S303: allocating a charging station to the target vehicle on the basis of the navigation information of the target vehicle and the predicted status information of the charging station; and
step S304: presenting, to a user of the target vehicle, location information of the allocated charging station and a navigation route to the allocated charging station.

18. The method according to claim 17, wherein in step S303, it is determined, on the basis of the navigation information of the target vehicle and the predicted status information of the charging station, whether an idle charging station is present in the preset region range of the navigation destination at a predicted time when the target vehicle reaches the navigation destination, wherein when an idle charging station is present in the preset region range of the navigation destination at the predicted time, then a charging station closest to the navigation destination is allocated to the target vehicle, or when no idle charging station is present in the preset region range of the navigation destination at the predicted time, then priority ranking is performed on charging stations in the preset region range of the navigation destination on a basis of a preset recommendation criterion, and a charging station is allocated to the target vehicle on a basis of the priority ranking of the charging stations, wherein different influencing factors are set for factors such as a distance to the navigation destination and a queuing time length according to the preset recommendation criterion, and the priority ranking is performed on the charging stations.

19. The method according to claim 14, wherein step S3 comprises:
step S311: obtaining the navigation information of the target vehicle, and determining, on the basis of the acquired vehicle charging information, whether charging behavior of the target vehicle is regular;
step S312: when the charging behavior of the target vehicle is regular, then assessing a charging start time of the target vehicle on the basis of the acquired charging information of the target vehicle, and predicting a predicted charging location of the target vehicle on the basis of the navigation information and the charging start time of the target vehicle;
step S313: predicting, on the basis of the stored leaving time of the vehicle of which charging behavior is regular, status information of a charging station in a preset region range of the predicted charging location;
step S314: allocating a charging station to the target vehicle on the basis of the navigation information of the target vehicle and the predicted status information of the charging station; and
step S315: presenting, to a user of the target vehicle, location information of the allocated charging station and a navigation route to the allocated charging station.

20. The method according to claim 14, wherein in step S2, the selecting is performed at a preset time interval, wherein the vehicle charging information, on which the selection is based, varies over time during acquisition.

21. The method according to claim 19, wherein in step S314, it is determined, on the basis of the charging start time of the target vehicle and the status information of the charging station in the preset region range of the predicted charging location, whether an idle charging station is present in the preset region range of the predicted charging location at the charging start time, wherein when an idle charging station is present in the preset region range of the predicted charging location at the charging start time, then an idle charging station closest to the predicted charging location is allocated to the target vehicle, or when no idle charging station is present in the preset region range of the predicted charging location at the charging start time, then priority ranking is performed on charging stations in the preset region range of the predicted charging location on the basis of a preset recommendation criterion, and a charging station is allocated to the target vehicle on the basis of the priority ranking of the charging stations, wherein different influencing factors are set for factors such as a distance to the predicted charging location and a queuing time length according to the preset recommendation criterion, and the priority ranking is performed on the charging stations.

22. The method according to claim 14, wherein step S3 comprises:
step S321: obtaining the navigation information and current charge level information of the target vehicle, wherein the navigation information comprises a navigation destination;
step S322: determining, on a basis of the current charge level information and the navigation information of the target vehicle, whether a current charge level of the target vehicle is sufficient to enable the target vehicle to reach the navigation destination;
step S323: when the current charge level of the target vehicle is not sufficient to enable the target vehicle to reach the navigation destination, then determining a predicted charging location and a predicted charging time of the target vehicle on the basis of the navigation information and the current charge level information of the target vehicle;
step S324: predicting, on the basis of the stored leaving time of the vehicle of which charging behavior is regular, status information of a charging station in a preset region range of the predicted charging location;
step S325: allocating a charging station to the target vehicle on the basis of the navigation information of the target vehicle and the predicted status information of the charging station; and
step S326: presenting, to a user of the target vehicle, location information of the allocated charging station and a navigation route to the allocated charging station.

23. The method according to claim 22, wherein in step S325, it is determined, on the basis of the predicted charging time of the target vehicle and the status information of the charging station in the preset region range of the predicted charging location, whether an idle charging station is present in the preset region range of the predicted charging location at the predicted charging time, wherein when an idle charging station is present in the preset region range of the predicted charging location at the predicted charging time, then an idle charging station closest to the predicted charging location is allocated to the target vehicle, or when no idle charging station is present in the preset region range of the predicted charging location at the predicted charging time, then priority ranking is performed on charging stations in the preset region range of the predicted charging location on the basis of a preset recommendation criterion, and a charging station is allocated to the target vehicle on the basis of the priority ranking of the charging stations, wherein different influencing factors are set for factors such as a distance to the predicted charging location and a queuing time length according to the preset recommendation criterion, and the priority ranking is performed on the charging stations.

24. The method according to claim 14, wherein the acquired vehicle charging information comprises a vehicle identifier, charging station basic information, an on/off signal of a charging pile, a charging current signal of the charging pile, vehicle start information, vehicle speed information, and/or vehicle location information, wherein the charging station basic information comprises a charging station identifier, charging station location information, a number of charging piles of a charging station, and/or a charging pile type.

25. A system (1) for smart allocation of a charging station, wherein the system (1) is configured to perform the method according to claim 14, comprising:
a charging information acquisition module (11) configured to acquire vehicle charging information;
a charging information processing module (12) configured to select, on a basis of the acquired vehicle charging information, a vehicle of which charging behavior is regular;
a storage module (13) configured to store the charging information of the vehicle of which charging behavior is regular;
a navigation module (14) configured to obtain navigation information input by a user of a target vehicle, wherein high-definition map information labeled with charging station basic information is stored in the navigation module (14);
an allocation module (15) configured to allocate a charging station to the target vehicle according to the navigation information and the stored charging information of the vehicle of which charging behavior is regular; and
an information notification module (16) configured to notify, to the user, location information of the allocated charging station and a navigation route to the allocated charging station.

26. A computer readable program carrier, comprising:
computer program instructions implementing, when executed by a processor, the steps of the method according to claim 14.
